(19) United States
(12) Patent Application Publication
(10) Pub. No.: US 2010/0167591 A1
(43) Pub. Date: Jul. 1, 2010

(54) CONNECTOR

(76) Inventors: Tsuyoshi Konno, Tokyo (JP); Katsuhiro Hori, Tokyo (JP); Takayuki Mori, Tokyo (JP); Makoto Watanabe, Tokyo (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/645,477

(22) Filed: Dec. 22, 2009

(30) Foreign Application Priority Data
Dec. 25, 2008 (JP) P2008-331450

(51) Int. Cl. H01R 24/00

(52) U.S. Cl. 439/626

(57) ABSTRACT

A connector includes a housing, a plurality of contacts, and a restricting member. The contacts are made of a conductive material. Each of the contacts includes a contacting part and a deformed part. The contacting part protrudes from the housing, is adapted to electrically come in contact with another connector, and is displaced in a first direction when contacts the another connecter. The deformed part is accommodated in the housing and is elastically deformed when the contacting part electrically comes in contact with the another connector. The restricting member is provided in the housing, is contacted to the deformed part, and restricts a displacement of the deformed part in a direction opposite to the first direction.

### BACKGROUND

This invention relates to a connector having a plurality of contact elements arranged in a row.

As a connector for interconnecting electronic equipments so as to transmit and receive data and electric power between the electronic equipments, there is known a conventional connector including an accommodating portion into which a mating connector is inserted, and contact elements mounted in the accommodating portion such that each of the contact elements is pressed by a corresponding contact element in the mating connector to be contacted therewith.

For example, Patent Document 1 discloses a connector including a housing having receiving portions open at their distal ends, and contact elements. The contact elements have elongated plate shape, and are elastically-deformable and inserted respectively into the receiving portions from the rear side of the housing. Distal end portions of the contact elements which serve as contact portions contact respectively with contact elements of a mating connector. The distal end portions are disposed in a projecting manner within the respective accommodating portions.

With this construction, when the contact elements of the mating connector are inserted respectively into the accommodating portions, the contact portion of each of the contact elements is pressed and deformed by a corresponding mating contact element to be contacted therewith.

It has been desired that such a conventional connector should be so constructed that a contact point of each contact element can be positioned stably at a predetermined position.

In the connector of Patent Document 1, an auxiliary jig separated from the housing is incorporated in the housing so as to press the contact elements respectively against walls of the accommodating portions. By incorporating this auxiliary jig into the housing, the contact elements are press-fitted respectively along the walls of the accommodating portions within the housing, and the contact portions of the contact elements are positioned respectively at the predetermined positions within the respective accommodating portions. In the connector of Patent Document 1, the contact elements are mounted in the housing so that the contact portion at the distal end portion of each contact element is stably positioned at the predetermined position.

[Patent Document 1] Japanese Patent Publication No. 2004-152640 A

In a conventional connector, however, the contact portions of the plurality of contact elements are positioned stably at the respective predetermined positions by the use of the auxiliary jig separated from the housing. Accordingly, when the connector is downsized, an auxiliary jig which is downsized and contact elements which is downsized are needed. Therefore, the assembling of the connector becomes cumbersome.

Furthermore, when inserting the contact elements into the housing by press-fitting, the auxiliary jig is inserted into the housing to press the each contact element so as to position the contact portion respectively at the predetermined position. Therefore, the positions of the contact portions of the contact elements press-fitted in the housing may be varied depending on the degree of pressing of the auxiliary jig.

### SUMMARY

It is therefore one advantageous aspect of the present invention is to provide a connector in which the precision of the position of a contact point of each of a plurality of contact elements arranged in a row is enhanced so that each contact element can be positively connected to a corresponding contact element of a mating electronic equipment with a proper pressure.

According to one aspect of the invention, there is provided a connector, comprising:
a housing;
a plurality of contacts, made of a conductive material, each of the contacts including
   a contacting part which protrudes from the housing, is adapted to electrically come in contact with another connector, and is displaced in a first direction when contacts the another connecter, and
   a deformed part which is accommodated in the housing and is elastically deformed when the contacting part electrically comes in contact with the another connector; and
a restricting member, provided in the housing, contacted to the deformed part, and restricting a displacement of the deformed part in a direction opposite to the first direction.

The connector may be configured such that the plurality of contacts are arranged in parallel with each other.

The connector may be configured such that: the deformed part urges the restricting member in a direction opposite to the first direction.

The connector may be configured such that: the restricting member is a projection provided on an inner face of the housing, the inner face opposing the deformed part.

The connector may be configured such that: the restricting member is disposed at an end portion of the inner face of the housing, the end portion exposed to the contacting part.

The connector may be configured such that: the restricting member and another restricting member are provided in the housing, and the restricting members are protruded a first dimension from an inner face of the housing , the inner face opposing the deformed part.

The connector may be configured such, that: the restricting member is formed with the housing monolithically.

The connector may be configured such that: the restricting member has a first face contacted to a face of the deformed part by face contact.

The connector: the first face of the restricting member is inclined with respect to the first direction.

The connector may be configured such that: each of the contacts includes a fixed part which is fixed in the housing, and the deformed part is provided between the contacting part and the fixed part.

The connector may be configured such that: the deformed part is disposed along an inner face of the housing opposite to an outer face opposing the another connector; and the deformed part has a first end portion which is connected to the fixed part, a second end portion which is opposite to the first end portion and is connected to the contacting part, and the restricting member is contacted to the deformed part at a position which is nearer the second end portion than the first end portion.

The connector may be configured such that: the first end portion is bent in an U-shape; the fixed part opposes the deformed part; and the contact has a connecting part adapted to electrically connect to a board and extended from the fixed part.

### BRIEF DESCRIPTION OF THE DRAWINGS

FIG. 1 is a plan view of a connector according to one embodiment of the invention.

FIG. 2 is a side view of the connector.

FIG. 3 is a front view of the connector.

FIG. 4 is a rear view of the connector.

FIG. 5 is a bottom view of the connector.

FIG. 6 is an extended cross-sectional view of the connector in a condition in which the connector is mounted on a board.

FIG. 7 is an extended cross-sectional view of a preload applying portion according to another embodiment of the invention.

### DETAILED DESCRIPTION OF EXEMPLIFIED EMBODIMENTS

Exemplified embodiments of the invention are described below in detail with reference to the accompanying drawings.

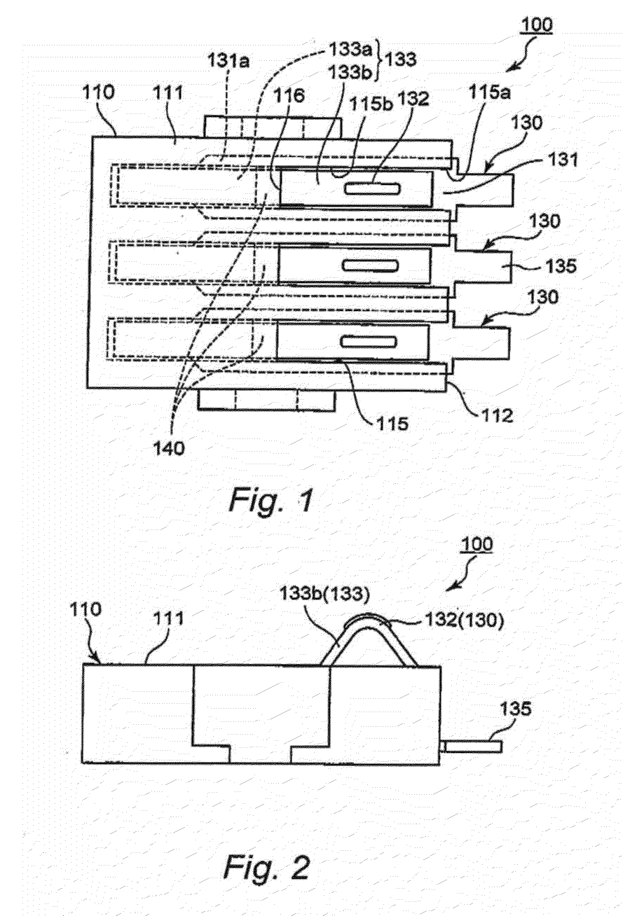

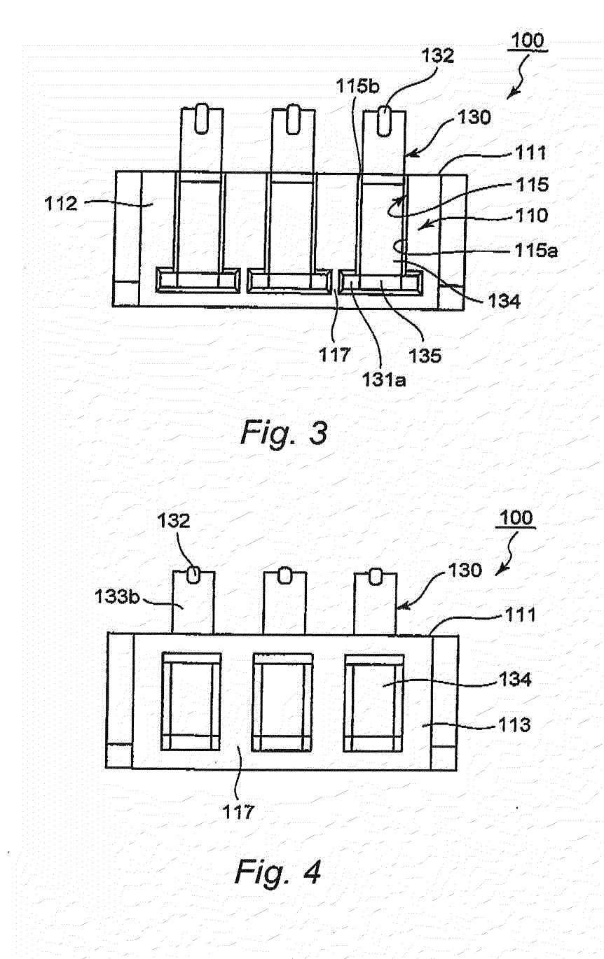

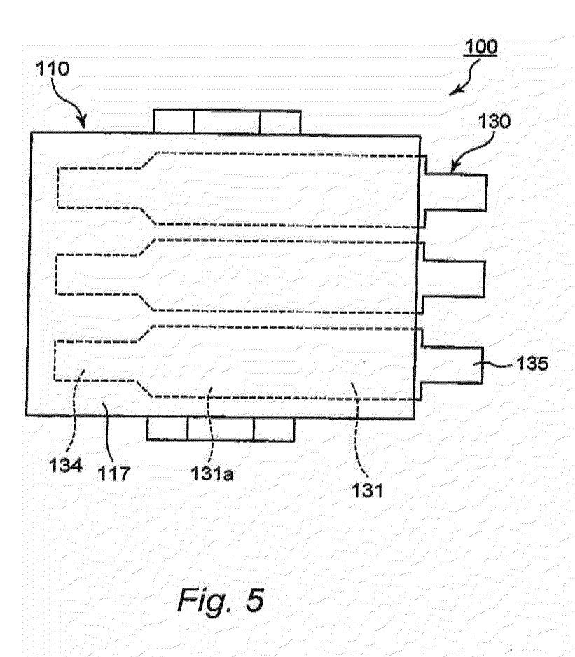

The connector 100 shown in FIGS. 1 to 5 comprises a housing 110, and a plurality of contact elements 130. The contact element 130 is accommodated in the housing 110 so that a contact portion 132 (a contacting part) of the contact elements 130 project outwardly from one surface. According to the present embodiment, the one surface is an outer or upper surface of an upper wall portion 111. The contact portions 132 contact respectively with contact elements of a mating electronic equipment.

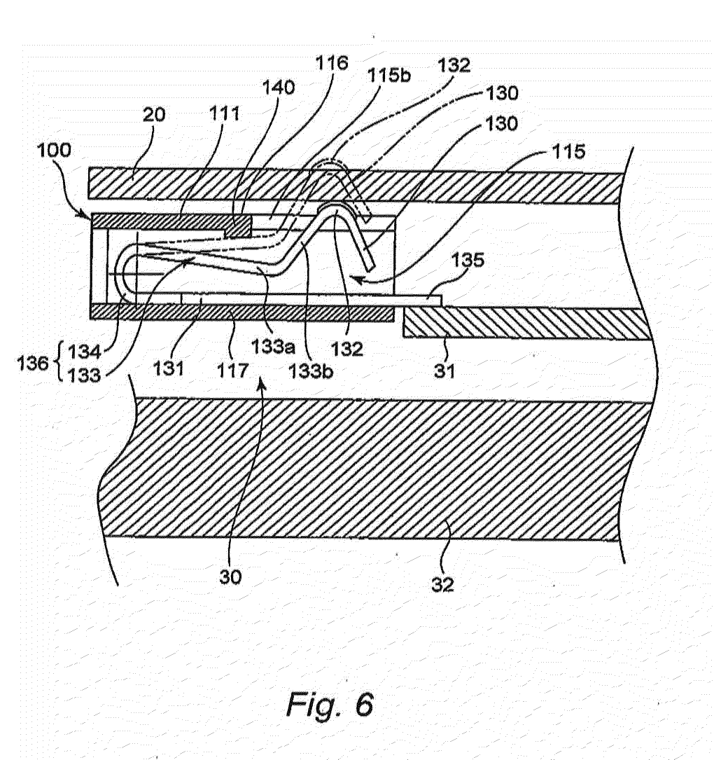

When the contact elements (i.e., electrodes provided on a reverse surface of a board 20 shown in FIG. 6) of the mating electronic equipment are provided above the upper wall portion 111 of the housing 110 of the connector 100, the contact portions 132 are electrically connected to the electrodes of the mating electronic equipment. The connector 100 is provided, for example, in a cradle 30 (see FIG. 6) on which the electronic equipment with a secondary battery such as a portable electronic equipment is placed. The connector 100 is connected to the electrodes of the electronic equipment placed on the cradle 30 so as to supply electric power to the secondary battery of the electronic equipment. In this case, the connector 100 serves as the power supply connector for supplying electric power to the secondary battery of the electronic equipment.

The housing 110 shown in FIGS. 1 to 5 is made of an electrically-insulative material such as an insulative resin, and is formed into a rectangular parallelepiped shape. A longitudinal direction of the housing 110 is called a forward-rearward direction, and a direction horizontally perpendicular to the forward-rearward direction is called a widthwise direction. Opposite end faces spaced from each other in the forward-rearward direction are called a front end face 112 and a rear end face 113, respectively.

A contact accommodating portion 115 for accommodating the contact element 130 is formed within the housing 110. The contact accommodating portion 115 is extend in the forward-rearward direction, and is opened to faces of the housing 110 which are connected each other. According to the present embodiment, the faces are the front end face 112 and the upper wall portion 111. The plurality of contact accommodating portions 115 are arranged in parallel each other in the widthwise direction at a predetermined pitch. The number of the contact elements 130 may be more than two. The number of the contact accommodating portions 115 is corresponded to the number of the contact elements 130.

A front opening 115a of the contact accommodating portion 115 which is opened at the front end face 112 serves as an insertion port which the contact element 130 is inserted thereinto by press-fitted. The contact portion 132 is disposed in an upper opening 115b which is open at the upper wall portion 111 so as to be projected retractably.

As shown in FIG. 6, the connector 100 is mounted on a board 31 mounted within a body of the cradle 30. The board 20 of the mating electronic equipment is placed on the connector 100. Reference numeral 32 denotes a bottom wall of the body of the cradle 30 comprising the connector 100.

The contact accommodating portion 115 has a preload applying portion 140 (a restricting member) formed on and projecting downwardly from a reverse surface of the upper wall portion 111 at a rear edge portion 116 of the upper opening 115b.

The preload applying portion 140 contacts an elastic piece portion 136 (a deformed part) of the contact element 130, which is elastically deformed in a pressing direction of the contact portion 132 (a first direction) in which the contact portion 132 is pressed by the contact elements of the mating electronic equipment. The preload applying portion 140 prevents the elastic piece portion 136 from being restored in a direction opposite to the pressing direction. Here, the preload applying portion 140 presses the contact element 130, accommodated in the contact accommodating portion 115, uniformly from an upper side of the connector 100, and applies a preload to the contact elements 130.

The preload applying portion 140 is monolithically formed with the housing 110 when the housing 110 is molded.

More specifically, a plurality of the preload applying portions 140 are formed on the upper wall portion 111 and project therefrom uniformly respectively toward the insides of the contact accommodating portion 115. In other words, the plurality of the preload applying portions 140 are formed on the reverse surface of the upper wall portion 111 in respectively corresponding to a plurality of the contact elements 130 and project same amount in the pressing direction.

The preload applying portion 140 presses a proximal end portion of the elastic piece portion 136. The proximal end portion is adjacent to a portion where the contact element 130 projects from the upper wall portion 111 of the housing 110. By doing so, the contact portion 132 projecting from the upper wall portion 111 of the housing 110 is positioned at a predetermined height position.

In the case where the plurality of contact accommodating portions 115 are replaced with a single contact accommodating portion defined by a single internal space of the housing 110 continuing in the widthwise direction, the plurality of preload applying portions 140 may be replaced by a single preload applying portion which is an elongated projection formed on and projecting downwardly from the upper wall portion 111 of the housing 110 and extending in the widthwise direction.

The contact element 130 includes a press-fitting piece portion 131 (a fixed part) for being fixed to a bottom wall portion 117 of the contact accommodating portion 115 by press-fitting, an arm portion 133 having the contact portion 132 at its distal end, a curved portion 134 interconnecting the arm portion 133 and the press-fitting piece portion 131, and a lead portion 135 (a connecting part).

The contact element 130 may be formed by processing an elastically-deformable wire-like or strip-like electrically-conductive member. According to the present embodiment, the contact element 130 is formed by processing an elongated narrow metal piece into the predetermined shape. The contact element 130 is accommodated in the contact accommodating portion 115 so that the contact portion 132 retractably projects from the upper wall portion 11 of the housing 110.

A width of the press-fitting piece portion 131 is larger than a width of the lead portion 135, a width of the curved portion 134, a width of the arm portion 133 and a width of the contact portion 132. Withdrawal prevention retaining piece portions (not shown) are formed at opposite side edge portions 131a (see FIGS. 1, 3 and 5) of the press-fitting piece portion 131. The retaining piece portions are held respectively against step portions formed on opposed side walls of an insertion groove (into which the press-fitting piece portion 131 is inserted) formed in the bottom wall portion 117. The press-fitting piece portion 131 is inserted into the insertion groove. Thereby, the withdrawal prevention retaining piece portions retain the contact element 130 against withdrawal.

When the press-fitting piece portion 131 is press-fitted into the bottom wall portion 117 of the contact accommodating portion 115 from the front opening 115a, this press-fitting piece portion 131 is fixed to the bottom wall portion 117 of the contact accommodating portion 115. Thereby, press-fitting piece portion 131 is fixedly mounted in the insertion groove in the bottom wall portion 117 of the housing 110. Therefore, the contact element 130 is fixed to the housing 110.

The press-fitting piece portion 131 is connected via the U-shaped curved portion 134 (with which this press-fitting piece portion 131 is continuous at one end thereof) to the arm portion 133. One end of the press-fitting piece portion 131 is continually formed with the U-shaped curved portion 134. The arm portion 133 is spaced a predetermined distance upwardly from the press-fitting piece portion 131 in opposed relation thereto.

The arm portion 133 extends upwardly from the curved portion 134 such that the distance between the arm portion 133 and the press-fitting piece portion 131 is increasing gradually toward the distal end of the arm portion 133. The arm portion 133 110 is disposed along the reverse surface of the upper wall portion 111. The arm portion 133 includes one side portion 133a continuous at a one end thereof with the press-fitting piece portion 131 via the curved portion 134, and an other side portion 133b which is bent at the other end of the one side portion 133a to project outwardly from the upper wall portion 111 and is continuous at a distal end thereof with the contact portion 132.

The arm portion 133, together with the curved portion 134, serves as a leaf spring for being elastically deformed toward and away from the press-fitting piece portion 131, and the arm portion 133 and the curved portion 134 jointly form the elastic piece portion 136 of the contact element 130.

The other side portion 133b of the arm portion 133 is not extended along the upper wall portion 111, but is bent at the other end of the one side portion 133a to be extended along the pressing direction. With this arrangement, a sufficient longitudinal length required for effecting an elastic deformation when the contact portion 132 is pressed down is secured. Therefore, the longitudinal length of the contact element 130 can be reduced, and the housing 110 for accommodating the contact elements 130 can be downsized.

The contact portion 132 includes the other side portion 133b bent at and extending upwardly from the other end of the one side portion 133a of the arm portion 133 and projecting upwardly from the upper wall portion 111. An apex portion formed by bending that portion of the contact element 130, extending from the distal end of the other side portion 133b, into a generally inverted U-shape. This apex portion is electrically contacted with the electrode of the mating electronic equipment, which is the electrode formed on the reverse surface of the board 20.

When the press-fitting piece portion 131 is fixed to the bottom wall portion 117 of the contact accommodating portion 115, the lead portion 135 is disposed to project horizontally outwardly from the front opening 115a. When the connector 100 is mounted on the board 31, the lead portion 135 is connected to a conductive pattern of the board 31. The lead portion 135 may be connected to a wire.

The contact element 130 of this construction accommodated in the contact accommodating portion 115 normally assumes a shape indicated by dashed line in FIG. 6, since the arm portion 133 is prevented by the preload applying portion 140 from upward movement.

When the contact portion 132 of the contact element 130 is pressed down by the electrode of the board 20 of the mating electronic equipment from the upper side, the curved portion 134 and the arm portion 133 are elastically deformed, and the contact portion 132 is moved downward, that is, toward the inside of the contact accommodating portion 115. This elastically-deformed condition of the contact element 130 is indicated by solid line in FIG. 6.

The contact element 130 is mounted in the contact accommodating portion 115 so that the arm portion 133 is pressed down by the preload applying portion 140.

Therefore, the plurality of the preload applying portions 140 monolithically formed uniformly on the housing 110 apply a preload to a plurality of the arm portions 133 of the plurality of contact elements 130 which the arm portions 133 are disposed immediately forwardly of the respective contact portions 132. As a result, the contact portions 132 continuous with the respective arm portions 133 at the distal ends thereof are disposed at the same height position.

According to the present embodiment, the contact element 130 is formed of the metal piece, and one end portion of the metal piece is used as the lead portion 135, and the portion of the metal piece extending from the distal end of the press-fitting piece portion 131 continuous with the lead portion 135 is bent to form the curved portion 134. Further, the portion of the metal piece extending from the distal end of the curved portion 134 is used as the arm portion 133, and the portion of the metal piece extending from the distal end of the arm portion 133 is bent to form the inverted U-shaped portion projecting away from the press-fitting piece portion 131, and the apex portion of the inverted U-shaped portion is used as the contact portion 132.

In this embodiment, a degree of curving of the curved portion 134 is so determined that the distance between the arm portion 133 and the press-fitting piece portion 131 is larger in a neutral condition of the contact element 130 than in the elastically deformed condition thereof obtained when the contact element 130 is accommodated in the contact accommodating portion 115. Therefore, merely by press-fitting the contact element 130 into the contact accommodating portion 115 through the front opening 115a, the arm portion 133 having the contact portion 132 formed at the distal end thereof is pressed toward the press-fitting piece portion 131 by the preload applying portion 140 within the contact accommodating portion 115.

According to the connector 100 of this embodiment, the plurality of contact elements 130 are press-fitted into the respective contact accommodating portions 115 of the housing 110 through the respective front openings 115a. Thereby, by assembling the connector 100 by the above mentioned way, the contact portions 132 of these contact elements 130 can be positioned at the same height position. Namely, there can be easily assembled the connector 100 in which even though the plurality of contact elements 130 are mounted in the housing 110, there is no variation in the height of the contact portions 132 of the contact elements 130.

Various constituent elements of an electronic device such as a connector have parts tolerances developing during the manufacture thereof, and also assembling tolerances develop when assembling these constituent elements into the electronic device. For example, the plurality of contact elements 130 usually have parts tolerances such that there is a variation in the distance between the arm portion 133 and the press-fitting piece portion 131. In the connector 100 according to the present embodiment, merely by press-fitting the plurality of contact elements 130 into the housing 110, these contact elements 130 can be mounted in the housing 110 so that the contact portions 132 are disposed at the same height position, thus eliminating the assembling tolerances developing when assembling the connector.

More specifically, when the contact elements 130 are press-fitted into the housing 110, the elastically-deformable portions (the arm portion 133) of the contact elements 130 disposed immediately forwardly of their respective contact portions 132 are pressed down uniformly respectively by the preload applying portions 140 of the same shape and size monolithically formed on the upper wall portion 111 of the housing 110. Therefore, the plurality of contact elements 130 are mounted in the housing 110 so that the contact portions 132 are disposed at the same height position.

Therefore, in the connector 100, a precision of the position of the contact point of each of the plurality of contact elements 130 mounted in the row in the housing 110 is enhanced so that each contact element 130 can be positively connected to the contact element of the mating electronic equipment with a proper pressure, Furthermore, even in the case where the connector 100 itself is downsized so that the plurality of contact elements 130 are arranged in the housing 110 at a reduced pitch, the precision of the position of the contact point of each contact element 130 can be enhanced by the provision of the preload applying portion 140, and the contact element 130 can be positively connected to the contact element of the mating electronic equipment with the proper pressure.

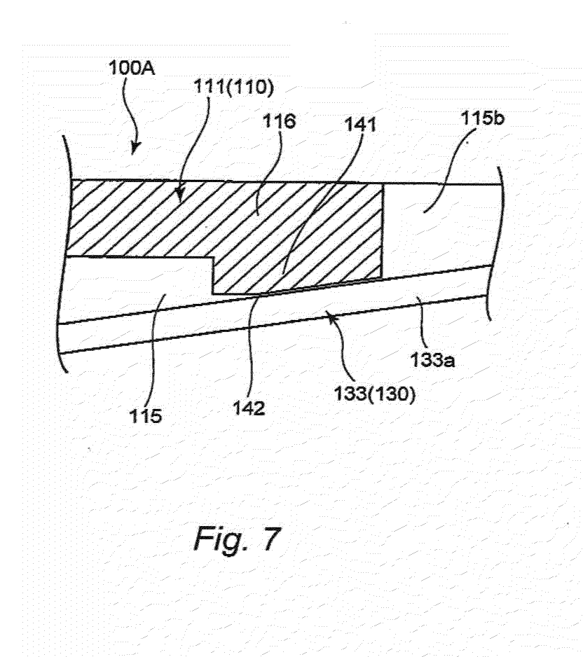

In the connector 100 according to this embodiment, the portion of the preload applying portion 140 for contacting the contact element 130 may be formed corresponding to shape of a portion of the contact element 130 which the preload applying portion 140 contacts. This modified example will be described below with reference to FIG. 7.

The connector 100A of FIG. 7 differs from the connector 100 only in the configuration of the preload applying portions 141. In the connector 100A, the preload applying portion 141 is formed on the reverse surface of the upper wall portion 111 of the housing 110 at the rear edge portion 116 of the upper opening 115b. Each preload applying portion 141 has a tapered face 142 corresponded to a shape of the arm portion 133 which the preload applying portion 141 contacts.

The tapered face 142 of the preload applying portion 141 is contacted with the elastic piece portion 136 of the corresponding contact element 130 by face contact, beforehand elastically deformed in the pressing direction of the contact portion 132, to prevent the elastic piece portion 136 from being restored in the direction opposite to the pressing direction. Therefore, merely by press-fitting the contact elements 130 into the housing 110 to mount these contact elements 130 in the respective contact accommodating portions 115 within the housing 110, the tapered face 142 of preload applying portion 141 contacts the arm portion 133 from the upper side generally over an entire area thereof to press the arm portion 133 downward.

Thus, in the connector 100A, the preload can be applied to the contact elements 130 more stably than in the connector 100, and each contact portion 132 can be positioned at the predetermined height position.

When molding the upper wall portion 111 of the housing 110, the preload applying portions 141 can be formed uniformly at the upper side of the respective contact accommodating portions 115 together with side walls separating the contact accommodating portions 115 from one another in the widthwise direction. Therefore, merely by incorporating the plurality of the contact elements 130 into the molded housing 110 by press-fitting, there can be easily assembled the connector in which the contact portions 132 of the contact elements 130 are disposed at the same height level.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

For example, the preload applying portions 141 may be formed as an additional member with respect to the housing 110, and be engaged on the upper wall portion 111 of the housing 110. Further, the preload applying portions 141 may be disposed at a position except for the rear edge portion 116 of the upper opening 115b.

The connector of the present invention has an advantage that the precision of the position of the contact point of each of the plurality of contact elements arranged in the row is enhanced so that each contact element can be positively connected to the contact element of the mating electronic equipment with the proper pressure, and the connector of the invention can be suitably used in a cradle for charging a terminal device, such as a cellular phone, a PDA and a portable music reproduction equipment, using a secondary battery as a power source.

The disclosures of Japanese Patent Application No. 2008-331450 filed Dec. 25, 2008 including specification, drawings and claims is incorporated herein by reference in its entirety.

What is claimed is:

1. A connector, comprising:
a housing;
a plurality of contacts, made of a conductive material, each of the contacts including
a contacting part which protrudes from the housing, is adapted to electrically come in contact with another connector, and is displaced in a first direction when contacts the another connecter, and
a deformed part which is accommodated in the housing and is elastically deformed when the contacting part electrically comes in contact with the another connector; and
a restricting member, provided in the housing, contacted to the deformed part, and restricting a displacement of the deformed part in a direction opposite to the first direction.

2. The connector as set forth in claim 1, wherein:
the plurality of contacts are arranged in parallel with each other.

3. The connector as set forth in claim 1, wherein:
the deformed part urges the restricting member in a direction opposite to the first direction.

4. The connector as set forth in claim 1, wherein:
the restricting member is a projection provided on an inner face of the housing, the inner face opposing the deformed part.

5. The connector as set forth in claim 4, wherein:
the restricting member is disposed at an end portion of the inner face of the housing, the end portion exposed to the contacting part.

6. The connector as set forth in claim 1, wherein:
the restricting member and another restricting member are provided in the housing, and
the restricting members are protruded a first dimension from an inner face of the housing, the inner face opposing the deformed part.

7. The connector as set forth in claim 1, wherein:
the restricting member is formed with the housing monolithically.

8. The connector as set forth in claim 1, wherein:
the restricting member has a first face contacted to a face of the deformed part by face contact.

9. The connector as set forth in claim 8, wherein:
the first face of the restricting member is inclined with respect to the first direction.

10. The connector as set forth in claim 1, wherein:
each of the contacts includes a fixed part which is fixed in the housing, and
the deformed part is provided between the contacting part and the fixed part.

11. The connector as set forth in claim 10, wherein:
the deformed part is disposed along an inner face of the housing opposite to an outer face opposing the another connector,
the deformed part has
a first end portion which is connected to the fixed part, and
a second end portion which is opposite to the first end portion and is connected to the contacting part, and
the restricting member is contacted to the deformed part at a position which is nearer the second end portion than the first end portion.

12. The connector as set forth in claim 11, wherein:
the first end portion is bent in an U-shape,
the fixed part opposes the deformed part, and
the contact has a connecting part adapted to electrically connect to a board and extended from the fixed part.
